(19) United States
(12) Patent Application Publication
(10) Pub. No.: US 2026/0246642 A1
(43) Pub. Date: Aug. 20, 2026

(54) 24HWS_Global Sovereign Communication Architecture

(71) Applicant: FURONG BEI, SAN GABRIEL, CA (US)

(72) Inventor: FURONG BEI, SAN GABRIEL, CA (US)

(21) Appl. No.: 19/170,666

(22) Filed: Apr. 4, 2025

(51) Int. Cl. H04L 9/32; H04L 9/08

(52) U.S. Cl. CPC H04L 9/3218; H04L 9/088; H04L 9/0894; H04L 9/3297

(57) ABSTRACT

A computer-implemented event value-conversion gateway binds a typed event to an addressable endpoint, identity anchor, endpoint context, time marker, proof object, governance profile, bounded correction state, and finality state. The endpoint may be rooted or rootless, domain-based or non-domain-based, cryptographic, device-based, session-based, institutional, or user controlled. Typed events may include communication, expression, authorization, payment-confirmation, service, IoT, publication, disclosure, transaction, or life-time economic events. A proof-object generator creates verification data, a value-conversion engine generates a policy-defined value record, and an output interface transmits licensing, transfer, minting, clearing, exchange, marketplace, audit, valuation, or index signals. A bounded correction controller applies callback, clawback, rollback, freeze, masking, annotation, reissuance, or restriction states, and a finality-state controller assigns pending, proofed, published, transferred, cleared, indexed, final, or closed states using anti-replay state, correction-window state, and finality-state transitions to reduce duplicate or inconsistent event-derived value records.

### 1. TITLE AND FIELD OF THE INVENTION

The invention relates to computer-implemented event verification, endpoint resolution, identity anchoring, value conversion, bounded correction, and finality control. It also relates to communication, expression, authorization, payment-confirmation, service, IoT, publication, disclosure, and life-time economic events that are transformed into proof-bearing value records.

The technical field includes network routing, endpoint-context resolution, identity and terminal binding, trusted event object generation, proof-object creation, privacy-preserving storage, correction-state control, and finality assignment. The invention can be implemented in a communication network, service platform, device mesh, application infrastructure, distributed ledger environment, enterprise workflow, intellectual-property publication system, or value clearing system.

Unless expressly recited in a claim, references to BEI, BEIDID, BEI-COMM, domain names, rooted domains, specific websites, specific currencies, tokens, NFTs, or named ecosystem portals are non-limiting implementation examples. The claimed invention is directed to technical structures, data objects, interfaces, state transitions, and computer-implemented operations that may be implemented under any branded, institutional, sovereign, enterprise, personal, cryptographic, or neutral naming system.

In preferred embodiments, BEI and BEI-COMM may describe a Behavioral Economics Identity implementation. In broader embodiments, any behavior-linked, event-linked, domain-bound, terminal-bound, wallet-bound, cryptographic, institutional, sovereign, enterprise, national, personal, or neutral identity system may implement the same technical architecture.

### 2. BACKGROUND—FRAGMENTATION RECORDS

Digital ecosystems generate enormous numbers of events: calls, messages, AI-agent instructions, payment confirmations, service requests, device signals, IoT observations, publication events, technical disclosures, and asset-transfer instructions. Conventional systems record these events in fragmented silos, and each silo uses a separate identity model, timestamp model, proof model, correction model, and finality model.

A communication application may retain a message log but not a transferable proof object. A payment platform may retain transaction evidence but not the surrounding authorization communication. A patent publication portal may record a filing but not connect the disclosure to a routable endpoint, identity anchor, licensing package, value-conversion record, correction window, and finality state.

The lack of a general event-to-value gateway creates uncertainty in AI automation, IoT-triggered actions, publication of inventions and materials, service authorization, compliance review, licensing, marketplace transfer, index formation, and dispute correction. A technical gateway is needed to bind events to resolvable endpoints, identity anchors, time markers, proof objects, governance profiles, correction states, and finality states.

The present disclosure addresses these problems through a structured state machine and interoperable data objects rather than through a single brand, domain, token, or application.

### 3. BACKGROUND—WHY NAMES, BRANDS, AND DOMAINS CANNOT BE REQUIRED

A robust event-value system cannot depend exclusively on one brand, one identity name, one domain name, one root domain, one currency name, one token name, or one website. A third party may implement equivalent functions using a public key, wallet address, DID, QR code, NFC tag, device identifier, application account, content hash, rootless peer-to-peer address, flat namespace, or institutional account.

For that reason, this disclosure uses generic terms such as addressable endpoint, endpoint context, identity anchor, typed event, time marker, proof object, governance profile, value-conversion record, bounded correction state, output signal, and finality state. Domain names and BEI terms are disclosed as powerful, non-limiting embodiments.

Non-limiting implementation examples may include BEICOMMS. com, BEISIGN. com, BEIPROOF. com, BEIMINT. com, ATMS. com, BEIGX. com, BEISX. com, BEIIndex. com, BEICLAWBACK. com, BEIROLLBACK. com, BEIFR 2.com, 120.us, MedicalCenter. us, 36JI. com, SZBF. com, ZGRX. com, Hours. us, days. us, week. us, year. us, yrs. us, and equivalent endpoints, accounts, identifiers, or namespaces. These examples may serve as portals, endpoints, namespace references, implementation websites, APIs, marketplaces, proof services, time-domain references, correction-control endpoints, rollback or clawback endpoints, audit endpoints, or strategy endpoints. The technical invention is not limited to any listed domain name, brand name, website, token name, root domain, DNS implementation, or endpoint provider. Equivalent non-domain, rootless, cryptographic, institutional, device, wallet, application, content-addressed, or machine-resolvable endpoints may implement the same claimed structure.

The technical invention is not the name of the endpoint. The technical invention is the gateway logic that makes an endpoint-originated or endpoint-associated event verifiable, provable, value-bearing, correctable, transferable, clearable, indexable, and finalizable.

### 4. SUMMARY OF THE INVENTION

The invention provides a resolvable-endpoint event value-conversion gateway. The gateway binds a typed event to an addressable endpoint, an identity anchor, an endpoint context, a time marker, a proof object, a governance profile, a bounded correction state, and a finality state. The gateway outputs a policy-defined value record, licensing signal, transfer signal, mint instruction, clearing signal, exchange eligibility signal, marketplace signal, audit signal, or index update.

The typed event may include a communication, expression, authorization, payment-confirmation, service, IoT, terminal, AI-agent, community, publication, patent-disclosure, material-disclosure, structure-disclosure, system-disclosure, discipline-publication, dataset, standard, protocol, resource, or life-time economic event.

The addressable endpoint may be rooted, rootless, hierarchical, flat, decentralized, federated, cryptographic, device-based, session-based, content-addressed, institutional, user-controlled, domain-based, non-domain-based, or equivalent. The identity anchor may be behavior-linked, event-linked, domain-bound, terminal-bound, device-bound, wallet-bound, public-key-bound, national, enterprise, institutional, sovereign, personal, or equivalent.

The system differs from mere messaging, mere timestamping, mere tokenization, or mere registry publication because it combines endpoint-context resolution, identity anchoring, typed-event intake, proof-object generation, value-conversion, bounded correction, and finality assignment within a single computer-implemented gateway.

In certain embodiments, the gateway improves operation of distributed event-processing systems by preventing duplicate value-conversion records, replayed proof objects, unauthorized reopening of final records, and inconsistent finality across heterogeneous endpoint namespaces through a proof-object state, anti-replay state, correction-window state, and finality-state controller.

### BRIEF DESCRIPTION OF THE DRAWINGS

FIG. 1 illustrates a high-level event value-conversion gateway including an addressable endpoint, endpoint-context resolver, identity-anchor verifier, typed-event intake, governance gate, and proof/value/finality processing.

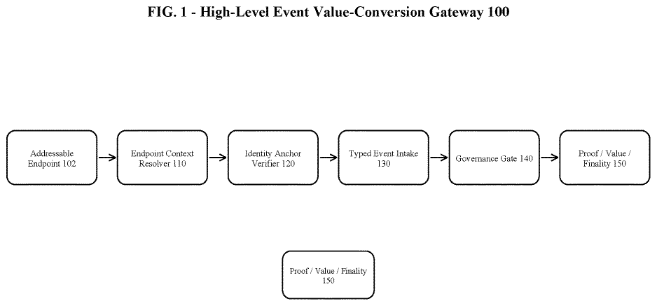

FIG. 2 illustrates representative addressable endpoint classes, including domain, DID/URI, wallet, device identifier, IoT endpoint, QR/NFC identifier, content hash, and application account classes.

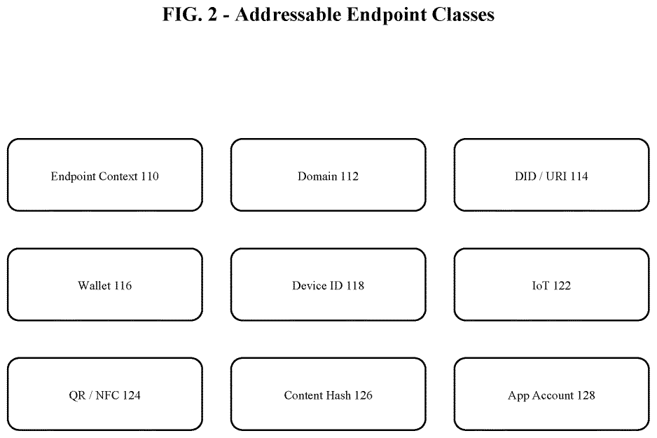

FIG. 3 illustrates event intake and routing context formation from endpoint, identity, event, governance, and output processing stages.

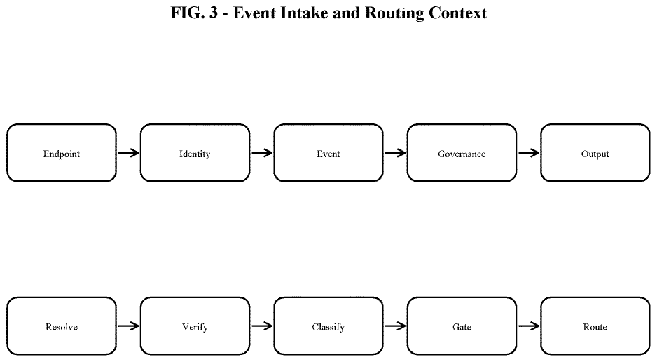

FIG. 4 illustrates a value record state machine including received, verified, proofed. eligible, minted, vaulted, disputed, frozen, corrected, cleared, indexed, and final states.

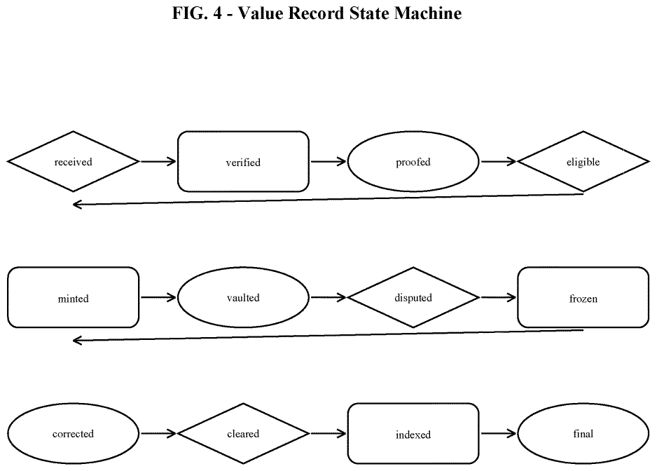

FIG. 5 illustrates representative identity anchor examples including subject ID, terminal ID, device certificate, wallet ID, public key, institution ID, behavior ID, and sovereign ID.

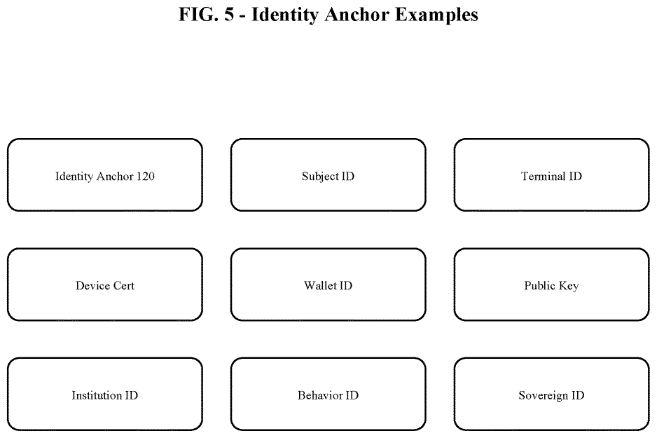

FIG. 6 illustrates representative typed event objects including communication. expression, authorization, payment confirmation, service/IoT, publication/disclosure, and life-time economic events.

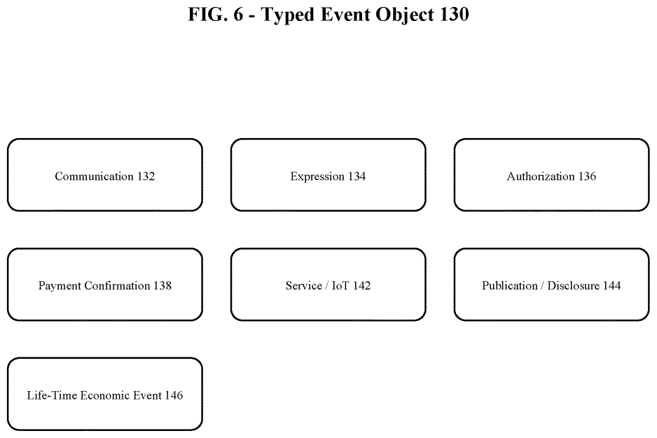

FIG. 7 illustrates AI and strategy governance flow from event intake through an AI gate. strategy profile, decision, and eligibility output.

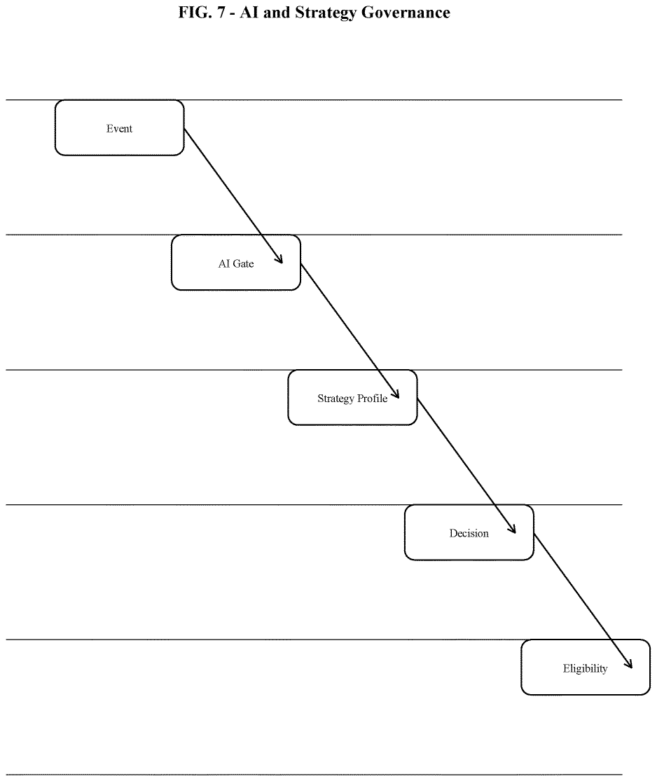

FIG. 8 illustrates a strategy profile matrix having routing, escalation, de-escalation, risk. licensing, and finality parameters with AI-gate, strategy-engine, and output records or signals.

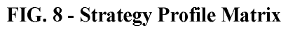

FIG. 9 illustrates time marker and window references including session, minute, hour, day, week, month, year, and policy-window references.

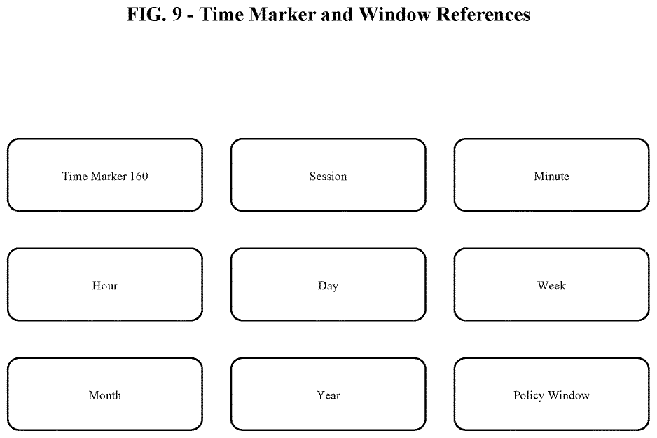

FIG. 10 illustrates proof object generation using event hash, identity hash, endpoint hash, time marker, nonce/counter, signature/policy, and proof object elements

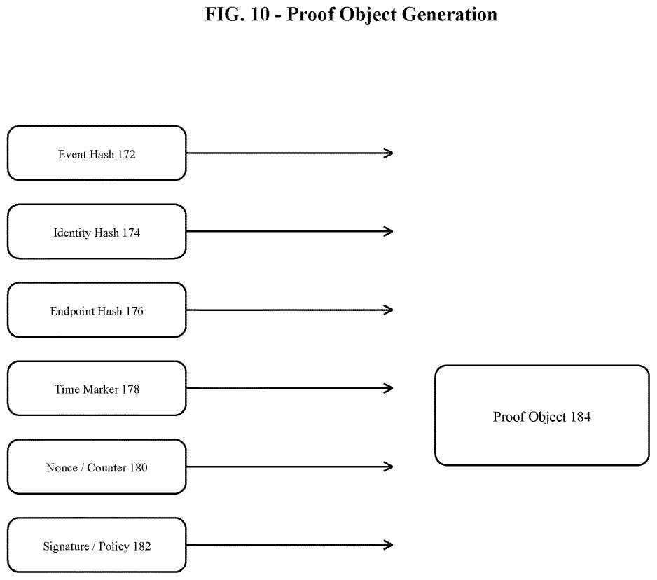

FIG. 11 illustrates a vault and disclosure record including encrypted payload, hash pointer, proof object, asset reference, publication reference, lifecycle state, confidentiality state, and audit snapshot elements.

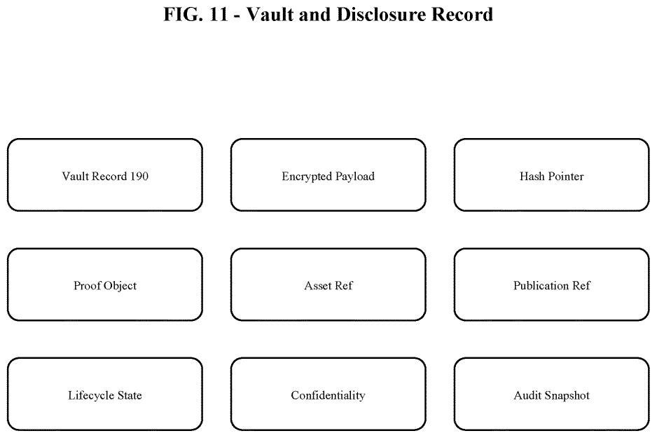

FIG. 12 illustrates a value-conversion engine receiving a proof object and eligibility decision, applying a value rule, and producing a value-conversion record and output interface signal.

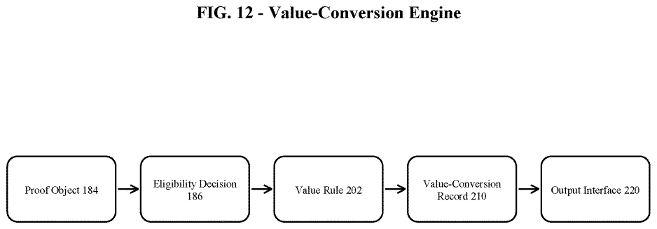

FIG. 13 illustrates representative value record output types including mint certificate. tokenized asset, service unit, time unit, currency unit, disclosure asset, and domain asset records or signals.

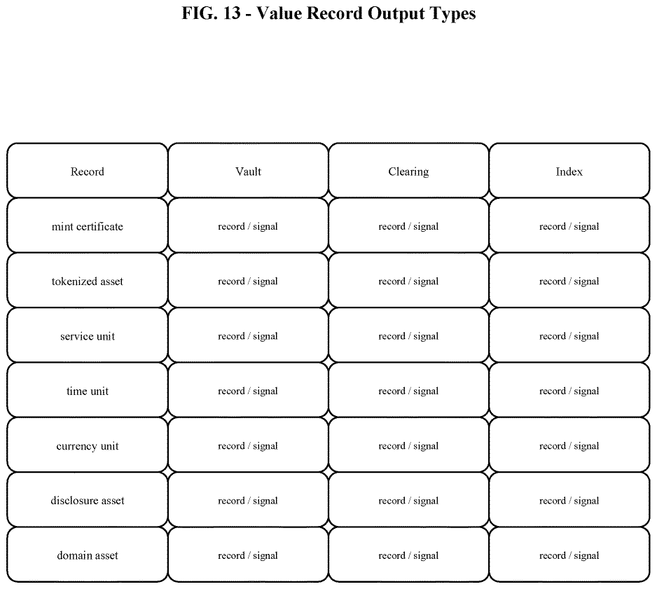

FIG. 14 illustrates a bounded correction controller with active, disputed, frozen, masked, annotated, reissued, clawed-back, rolled-back, corrected, expired, invalidated, and closed states.

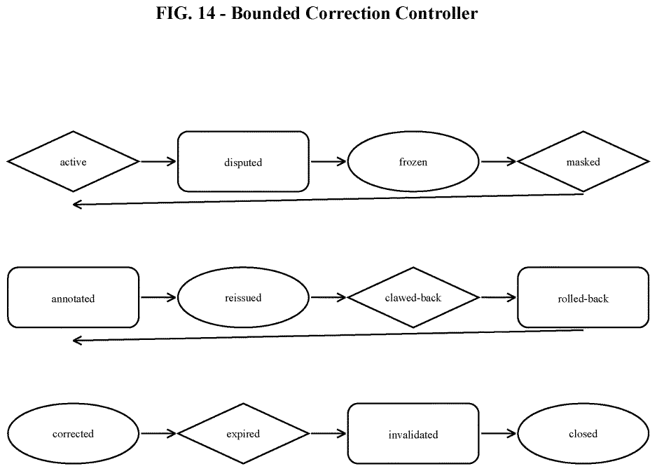

FIG. 15 illustrates a callback, clawback, and rollback flow including trigger, correction, vault, output, and finality processing.

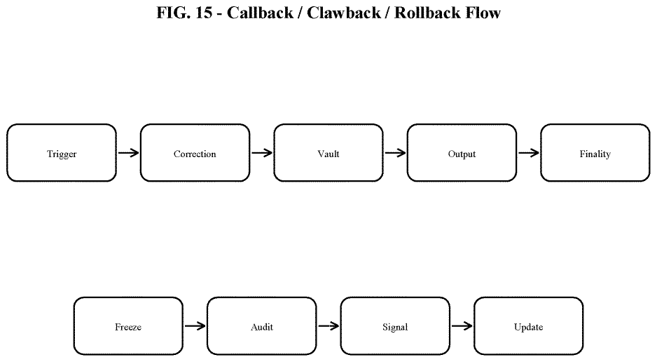

FIG. 16 illustrates a finality-state controller including pending, proofed, published/minted. cleared/settled, indexed, and final/closed states.

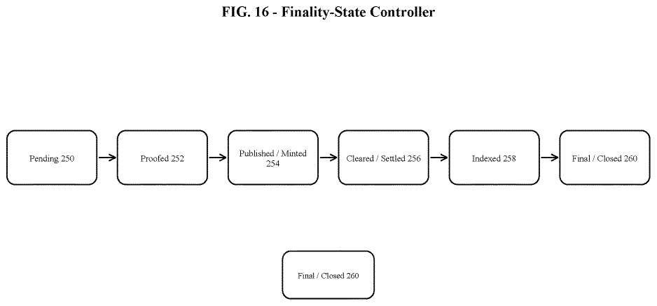

FIG. 17 illustrates a publication and disclosure layer including patent, domain, material. structure, system, dataset, standard, and discipline disclosure objects.

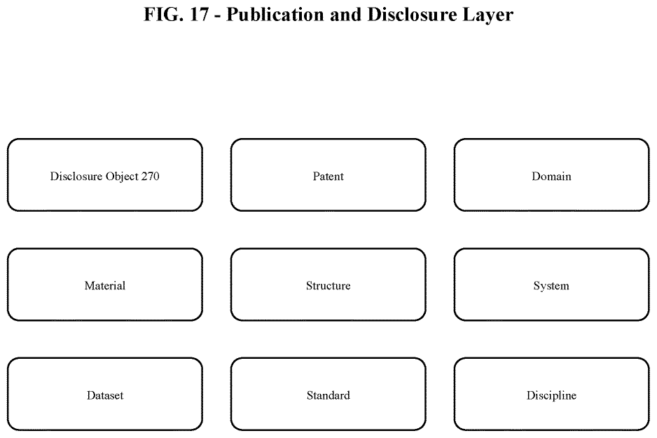

FIG. 18 illustrates an IP licensing and transfer interface including disclosure object, proof package, license, transfer, and finality processing.

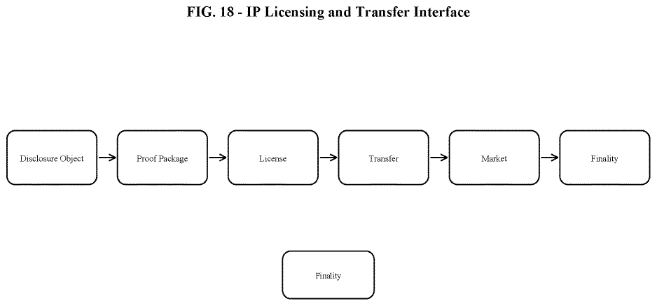

FIG. 19 illustrates a principal value and currency interface for principal unit, time unit. behavior unit, service unit, communication asset, and publication asset records or signals through mint. clear, and index paths.

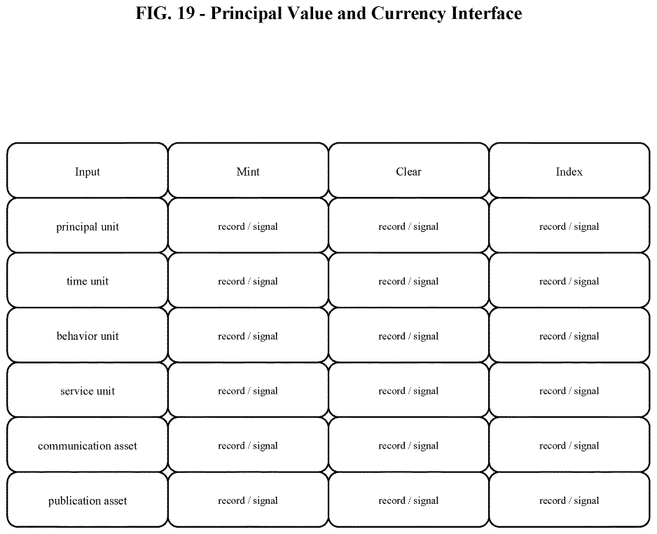

FIG. 20 illustrates IoT and personalized terminal binding examples including mobile device, television, wearable device, sensor, vehicle, ATM, factory device, and AI agent.

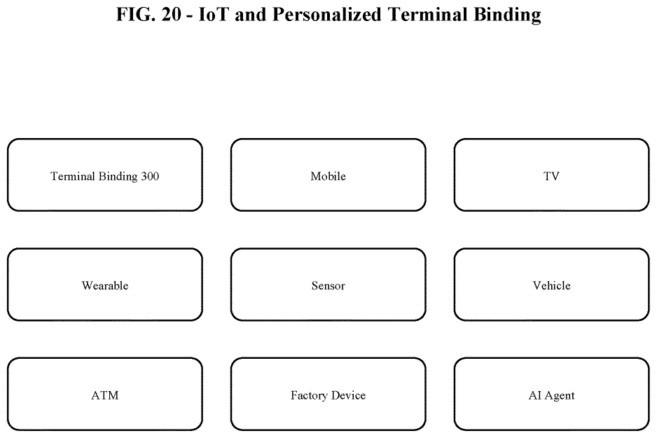

FIG. 21 illustrates an IoT event to value record flow from device/sensor through endpoint context, identity anchor, typed event, proof object, value record, and finality.

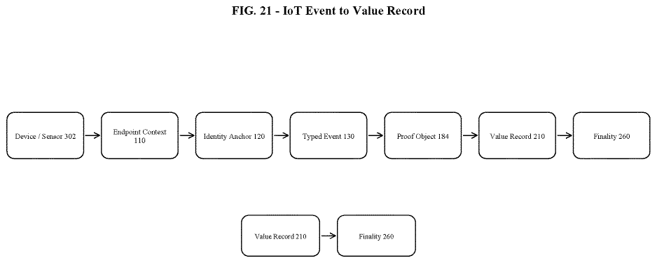

FIG. 22 illustrates clearing, exchange, marketplace, and index outputs generated from a value record.

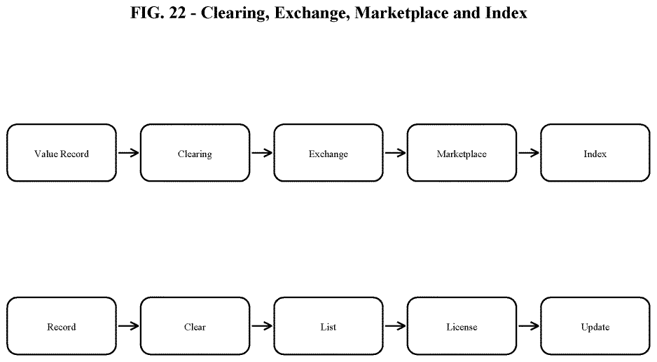

FIG. 23 illustrates a non-limiting endpoint matrix including BEICOMMS, BEISIGN, BEIPROOF, BEIMINT, ATMS, BEIGX/BEISX, 120.us/MedicalCenter. us, and equivalent endpoints.

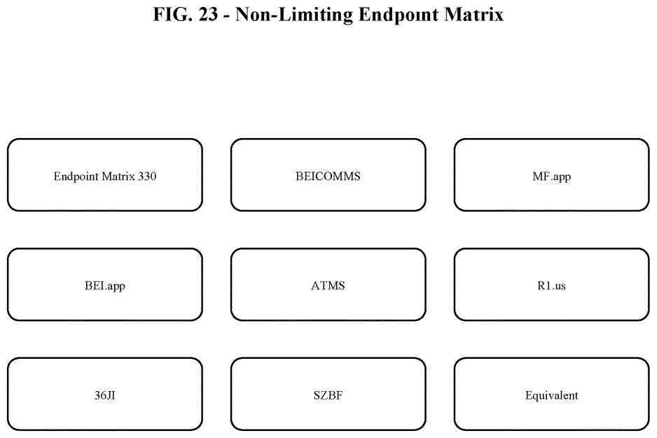

FIG. 24 illustrates anti-replay and duplicate-prevention processing including new event. nonce set, proof locked, record issued, duplicate check, correction window, finality window, and closed states

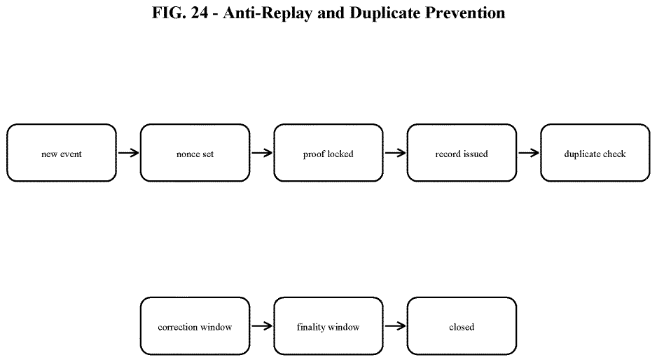

FIG. 25 illustrates three-peak portfolio separation among platform, communication, and health cases across service platform, communication event, telehealth minute, and value-finality layers.

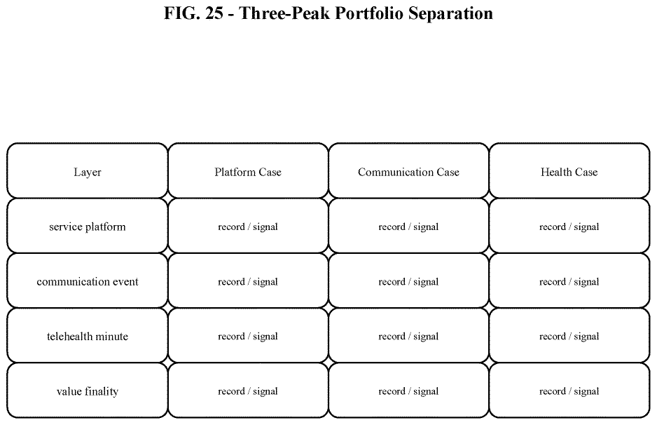

FIG. 26 illustrates system data objects including endpoint context, identity anchor, typed event, proof obiect, value record, correction state, and finality state.

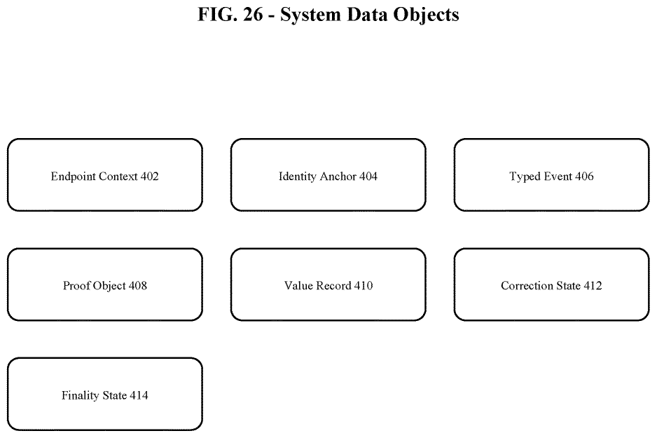

FIG. 27 illustrates governance outputs including allow, deny, delay, escalate, proof-only. license-eligible, clear-eligible, and index-only outputs.

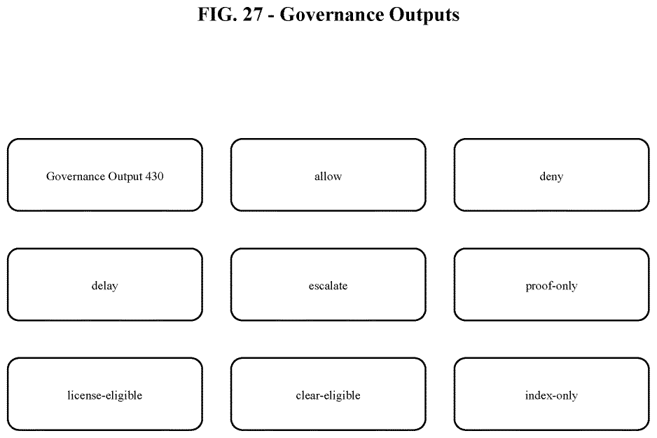

FIG. 28 illustrates end-to-end gateway operation from addressable endpoint through identity anchor, typed event, time marker, proof object, value record, correction controller, output interface, and finality state.

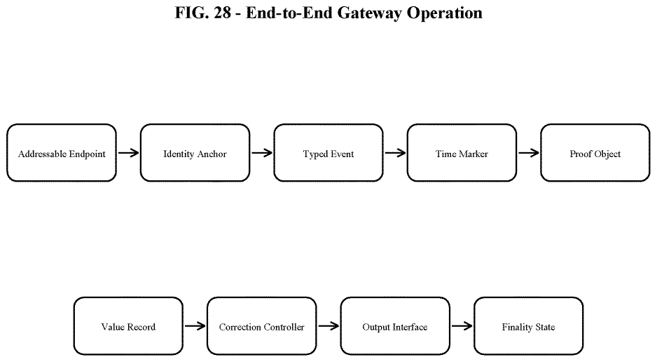

### 5. THREE-PEAK PORTFOLIO BOUNDARY

This case is intended to cooperate with related portfolio peaks without unnecessarily duplicating them. One related peak may protect a sovereign service platform, behavior-time fabric, readable addressing, service bus, microservices, and multi-chain anchoring. Another related peak may protect telehealth video sessions, BEI Minute computation, medical behavior segmentation, health assets, tri-header receipts, and medical rollback.

The present case is directed to a broader but technically distinct event value-conversion gateway. It does not require a particular sovereign data bus, nor does it require telehealth clinical segmentation. It can receive communication, expression, authorization, service, IoT, publication, and disclosure events from many infrastructures and convert such events into proof-bearing, correctable, transferable, mintable, clearable, indexable, and finalizable value records.

This separation supports a three-dimensional protection strategy: a platform layer, a vertical medical time-behavior layer, and a general event-value gateway layer. The general gateway layer is the present disclosure.

The present disclosure is therefore useful as a cross-system gate that can interact with total service platforms, telehealth systems, communication systems, IP publication portals, IoT infrastructures, AI-agent platforms, wallets, clearing systems, marketplaces, and index engines without becoming limited to any one of them.

The present disclosure does not claim a telephone network, payment rail, telehealth clinical workflow, or domain-name registry as such; rather, it claims a gateway layer that receives externally generated typed events and converts them into proof-bearing, correctable, transferable, mintable, clearable, indexable, and finalizable value records.

### 6. Definitions—Addressable Endpoint

An addressable endpoint means any endpoint, identifier, account, reference, address, namespace entry, device reference, content reference, terminal reference, or routing reference that can be resolved or associated with an event context. The endpoint may be rooted or rootless, hierarchical or flat, centralized or decentralized, federated or peer-to-peer, human-readable or machine-readable.

Examples include domain names, subdomains, DNS records, ENS names, DID records, URLs, URIs, IP addresses, wallet addresses, public keys, device IDs, IoT endpoints, telephone identifiers, application accounts, QR-code identifiers, NFC identifiers, content hashes, session IDs, institutional identifiers, national identity references, enterprise accounts, patent publication endpoints, material source endpoints, and equivalent references.

The endpoint is used to establish an event routing context. The routing context may identify a subject, device, service, publication node, terminal, wallet, asset, material, system, discipline, resource, marketplace, clearing interface, index interface, or finality controller.

A rooted domain name may be a preferred embodiment because it provides human-readable namespace delegation. However, rootless and non-domain implementations may still perform equivalent endpoint-context resolution.

### 7. Definitions—Identity Anchor

An identity anchor means a cryptographic, behavioral, institutional, terminal, domain, wallet, device, national, enterprise, sovereign, personal, or other subject identity reference that can be used to verify a party, device, agent, node, terminal, publication, resource, material, system, or service associated with a typed event.

In some embodiments, identity anchors may include BEIDID, BEIEID, BehaviorID, user account identifiers, public keys, wallet addresses, device certificates, secure enclave identifiers, domain-control proofs, institution-issued credentials, passkeys, decentralized identity credentials, or equivalent identity references.

The identity anchor is not limited to a brand name. Any system that verifies who or what is associated with the event may provide an identity anchor if it participates in the claimed event-verification, proof-generation, value-conversion, correction, and finality workflow.

The identity anchor may be bound to an endpoint, terminal, IoT device, AI agent, publication record, material disclosure, service record, or value-conversion record.

### 8. Definitions—Typed Event

A typed event means a computer-detectable or computer-recorded occurrence that is classified as one or more event types and is eligible for verification, proof generation, value conversion, correction control, or finality assignment. The event may originate from a person, institution, AI agent, terminal, device, application, publication node, IoT endpoint, community, service module, or marketplace.

Typed events may include voice calls, video sessions, text messages, data exchanges, AI dialogues, commands, signals, broadcasts, authorization events, payment confirmations, service requests, IoT observations, terminal interactions, community participation, governance messages, patent disclosures, domain publications, material disclosures, structure disclosures, system disclosures, discipline publications, datasets, standards, protocols, transactions, and life-time economic events.

A typed event may carry fields such as event identifier, source endpoint, destination endpoint, identity reference, device reference, time marker, event type, evidence hash, payload pointer, metadata, policy version, governance profile reference, correction window, value eligibility indicator, and finality state.

The use of typed events allows communication, publication, service, IoT, and economic events to share a common gateway without reducing the invention to any single event category.

### 9. Definitions—Time Marker and Time-Domain Window

A time marker means a timestamp, time interval, session marker, sequence number, nonce, counter, time-domain endpoint, validity period, policy-effective period, correction window, settlement cycle, or finality window associated with a typed event.

The time marker may be implemented using a clock time, ledger timestamp, trusted timestamp, device timestamp, server timestamp, cryptographic time proof, content-time reference, or time-domain namespace reference. Non-limiting examples of time-domain endpoints include R1.us, days. us, week. us, year. us, and other hour, day, week, month, year, or policy-defined timestamp namespaces.

The time marker may be used to prevent replay, restrict correction to a bounded interval, determine mint eligibility, establish publication priority, define a licensing period, apply jurisdictional policy, trigger clawback, assign finality, or update an index.

The time marker does not require a particular currency or time token. It is a technical element that binds an event to a measurable, verifiable, or policy-defined temporal context.

### 10. Definitions—Proof Object

A proof object means a data object generated from a typed event and associated context to support later verification. A proof object may include an event hash, identity hash, endpoint hash, payload hash, disclosure hash, timestamp, nonce, counter, signature, credential reference, sensor attestation, policy version, governance profile reference, correction-window reference, anti-replay state, and vault pointer.

The proof object may be privacy-preserving. It may reference encrypted payloads, zero-knowledge commitments, selective disclosure credentials, redacted evidence packages, hashed documents, or masked communication records while preserving later verification capability.

The proof object is a key bridge between raw event occurrence and value conversion. Without a proof object, a gateway may refuse to generate a transferable value record, mint instruction, clearing signal, licensing package, index update, or finality state.

The proof object may be reused across communication assets, service units, publication proofs, patent-disclosure records, material-disclosure records, terminal records, and currency or token records.

### 11. Definitions—Value-Conversion Record

A value-conversion record means a data object or instruction that represents an event-derived value outcome. The record may include a mint certificate, value record, tokenized asset record, currency instruction, time-denominated unit, service unit, communication asset, behavior asset, publication asset, patent-disclosure asset, material-disclosure asset, domain asset, licensing signal, transfer signal, marketplace signal, clearing signal, exchange eligibility signal, audit signal, or index update.

The record may be transferable, non-transferable, proof-only, restricted, confidential, licensed, listed, expired, frozen, disputed, corrected, settled, indexed, final, or closed. These status fields enable the system to produce useful records without assuming that every event should be freely traded.

Examples may include BEI Currency, BICurrency, TimeCurrency, TalkingNFT, communication tokens, service credits, patent-publication assets, material-disclosure assets, domain assets, licensing packages, and equivalent value units. These examples are not required limitations.

The value-conversion record is generated only after the gateway applies endpoint context, identity verification, event classification, governance, time marking, proof generation, and correction controls as configured by policy.

### 12. Definitions—Bounded Correction and Finality

A bounded correction state means a computer-controlled state applied to a value-conversion record, proof object, publication record, communication asset, service unit, mint instruction, clearing record, or index update to correct errors, fraud, unauthorized access, coercion, misrouting, privacy issues, stale policy, duplicate minting, duplicate clearing, or other trigger conditions.

Correction states may include pending, active, restricted, disputed, frozen, masked, annotated, corrected, reversed, clawed back, rolled back, recalled, reissued, expired, invalidated, settled, indexed, final, or closed. Procedures may include callback, clawback, rollback, freeze, mask, annotation, reissuance, and dispute marking.

A finality state means a terminal or semi-terminal state assigned after proof, policy, correction-window, dispute, rollback, clearing, settlement, licensing, transfer, publication, or indexing conditions have been satisfied. The finality state may prevent unauthorized reminting, duplicate publication, duplicate clearing, unauthorized transfer, or replay.

Bounded correction and finality distinguish the invention from simple timestamping or tokenization. They provide a safety valve and a closure rule for value-bearing event records.

### 13. Overall Gateway Architecture

The gateway includes an endpoint-context resolver, identity-anchor verifier, typed-event intake module, governance gate, time-marker module, proof-object generator, value-conversion engine, vault or disclosure-record module, bounded correction controller, output interface, and finality-state controller. The modules may be physically centralized, distributed, federated, peer-to-peer, chain-based, device-based, cloud-based, local, or hybrid.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 14. Endpoint-Context Resolver

The resolver converts an addressable endpoint into an event routing context. It may process rooted domains, rootless identifiers, public keys, content hashes, device IDs, application accounts, wallets, QR codes, NFC tags, IoT endpoints, terminal IDs, or publication nodes. The routing context may identify policy, jurisdiction, device class, value eligibility, disclosure scope, or finality rules.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 15. Identity-anchor Verifier

The verifier authenticates a subject, terminal, device, AI agent, institution, resource, publication node, or service using one or more identity anchors. The verifier may perform credential validation, signature verification, device attestation, passkey verification, DID resolution, wallet verification, account validation, behavior-linked identity matching, or institution-issued credential checking.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 16. Typed-event Intake Module

The intake module receives and normalizes events from communication systems, IoT endpoints, publication portals, service applications, payment-confirmation channels, AI-agent systems, terminal devices, community platforms, and disclosure systems. The intake module generates or receives an event object with fields needed for later proof and value conversion.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 17. Governance Gate

The governance gate evaluates event type, identity assurance, endpoint context, intent, risk, urgency, jurisdiction, consent, confidentiality, resource category, disclosure type, licensing readiness, value eligibility, and correction-window requirements. It may output allow, deny, delay, escalate, proof-only, publish-eligible, license-eligible, mint-eligible, clear-eligible, index-only, or quarantine states.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 18. Strategy-Governance Doctrine Layer

The governance gate may receive machine-readable strategy profiles from strategy endpoints or doctrine engines. Non-limiting examples include 36ji. com as a Thirty-Six Stratagems strategy engine and szbf. com as a Sunzi Bingfa strategic-governance endpoint. These examples may provide routing priorities, deception-risk indicators, escalation rules, de-escalation rules, emergency levels, confidentiality rules, licensing readiness scores, and value-eligibility weights.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 19. Time-Marker Module

The time-marker module binds the event to a time marker, session window, nonce, counter, sequence position, correction window, settlement cycle, publication priority window, or finality window. Time-domain endpoints such as R1.us, days. us, week. us, and year. us may be used as non-limiting examples of timestamp namespace references.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 20. Proof-Object Generator

The proof-object generator creates a verifiable object from endpoint context, identity verification, event classification, time marker, governance profile, signatures, hashes, anti-replay state, correction window, and evidence pointers. The proof object may be used without exposing raw private content.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 21. Vault and Disclosure-Record Module

The vault module stores encrypted event records, proof objects, hash pointers, asset references, publication records, disclosure records, lifecycle states, confidentiality states, correction states, and audit records. The disclosure-record module can handle patent disclosures, technical documents, domain publications, materials, structures, systems, disciplines, datasets, standards, and protocols.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 22. Value-Conversion Engine

The value-conversion engine determines whether a verified event should produce a proof-only record, value record, mint instruction, licensing package, transfer package, service unit, communication asset, behavior asset, patent-disclosure asset, material-disclosure asset, principal value unit, clearing signal, marketplace signal, index update, or no value output.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 23. Principal Value Interface

The principal value interface may generate or transmit minting instructions, clearing instructions, exchange eligibility signals, index updates, licensing outputs, transfer outputs, settlement instructions, or finality-state records. Examples include BEI Currency, BICurrency, TimeCurrency, service units, communication assets, behavior assets, patent-disclosure assets, material-disclosure assets, domain assets, and equivalent records.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 24. Bounded Correction Controller

The bounded correction controller applies callback, clawback, rollback, freeze, masking, annotation, dispute marking, reissuance, invalidation, or reversal states to value-conversion records, proof objects, or output signals. It may preserve a privacy-protected audit trail in the vault while preventing unauthorized replay, duplicate correction, or hidden alteration.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 25. Finality-State Controller

The finality-state controller assigns a pending, proofed, published, licensed, transferred, minted, disputed, frozen, corrected, clawed-back, rolled-back, cleared, settled, indexed, final, or closed state to a record. Finality may be conditioned on proof, policy, correction-window expiration, clearing, settlement, marketplace transfer, licensing execution, or index publication.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 26. Output Interface

The output interface transmits vault records, audit snapshots, licensing signals, transfer signals, publication proofs, inventor proofs, mint instructions, clearing signals, exchange eligibility signals, marketplace listing signals, valuation metadata, index updates, correction notices, and finality states to downstream systems.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 27. Security and Privacy Controls

Security controls may include encryption, hardware security modules, secure enclaves, passkeys, device attestation, zero-knowledge commitments, selective disclosure, payload masking, redacted evidence packages, role-based access, jurisdiction-specific controls, and confidential vault pointers.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 28. Anti-Replay and Anti-Duplication

Anti-replay controls may use nonce, counter, sequence, timestamp, endpoint context, proof-object hash, identity signature, correction-state check, consumed-proof state, or finality-state check. Anti-duplication controls may prevent duplicate minting, duplicate licensing, duplicate publication, duplicate clearing, duplicate indexing, or unauthorized transfer.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 29. Publication and Patent-Disclosure Events

A publication event may relate to an invention disclosure, patent application, provisional disclosure, technical document, claim family, prior publication, figure set, dataset, standard, protocol, or licensing package. A patent object may include title, inventor, assignee, endpoint reference, disclosure hash, claim-family reference, priority marker, evidence package, licensing status, and finality state.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 30. Material, Structure, System, and Discipline Disclosures

A disclosure event may include material compositions, source data, property records, test references, structural designs, component relationships, system modules, state machines, scientific classifications, ontology entries, discipline standards, datasets, protocols, or knowledge graphs. These objects can become typed disclosure records rather than unbounded claims to every material or discipline.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 31. IoT and Personalized Terminal Binding

A personalized identity terminal or IoT endpoint may bind a device certificate, sensor identifier, secure enclave identifier, terminal identifier, user identity, domain or non-domain endpoint, time marker, and event type. Examples include phones, computers, smart televisions, wearables, medical sensors, vehicle terminals, factory devices, home devices, ATMS terminals, laboratory instruments, AI-agent terminals, and publication nodes.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 32. Communication and Expression Events

Communication events may include voice, video, message, data exchange, AI dialogue, command, broadcast, emergency signal, authorization communication, payment-confirmation communication, community expression, governance proposal, educational interaction, medical communication, family communication, commercial negotiation, or service confirmation.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 33. Authorization and Payment Confirmation Events

An authorization or payment-confirmation event may produce a proof-only record, value-conversion record, clearing signal, transfer signal, correction-state record, or finality state without requiring the claimed gateway to be the underlying payment system. The invention protects the technical event-to-proof-to-value-to-finality conversion gateway rather than a conventional payment rail itself.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 34. AI-Agent and Machine-Initiated Events

AI agents may initiate, recommend, relay, classify, or execute events. The gateway may require identity anchoring, authority verification, provenance proof, time marking, strategy-governance checks, correction windows, and finality states before an AI-agent event becomes a transferable, mintable, licensable, or clearable value record.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 35. Strategy Profiles and Cultural Doctrine Embodiments

Cultural or strategic doctrine may be translated into machine-readable policy weights. Examples include routing priority, conflict escalation, conflict de-escalation, deception-risk indicators, alliance indicators, emergency-response levels, confidentiality scope, publication eligibility, licensing readiness, and transfer risk. The examples 36ji. com and szbf. com are implementation endpoints, not claim limitations.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 36. Non-Limiting Domain and Ecosystem Examples

Non-limiting implementation examples may include BEICOMMS.com, BEISIGN.com, BEIPROOF.com, BEIMINT.com, ATMS.com, BEIGX.com, BEISX.com, BEIIndex.com, BEICLAWBACK.com, BEIROLLBACK.com, BEIFR2.com, 120.us, MedicalCenter. us, 36JI.com, SZBF.com, ZGRX.com, Hours.us, days.us, week.us, year.us, yrs.us, and equivalent endpoints, accounts, identifiers, or namespaces. These examples may serve as portals, endpoints, namespace references, implementation websites, APIs, marketplaces, proof services, time-domain references, correction-control endpoints, rollback or clawback endpoints, audit endpoints, or strategy endpoints. The technical invention is not limited to any listed domain name, brand name, website, token name, root domain, DNS implementation, or endpoint provider. Equivalent non-domain, rootless, cryptographic, institutional, device, wallet, application, content-addressed, or machine-resolvable endpoints may implement the same claimed structure.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 37. Value Records and Asset Classes

Value records may include communication assets, behavior assets, service units, proof-only records, non-transferable credentials, transferable assets, licensing packages, patent-disclosure assets, material-disclosure assets, domain assets, time-denominated units, currency instruments, marketplace listing records, or index records. The broad claim does not require any one token or NFT implementation.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 38. Licensing, Transfer, and Marketplace Outputs

The gateway may output licensing packages, transfer packages, marketplace listing signals, valuation metadata, publication proofs, inventor identity proofs, asset provenance records, transaction records, and finality states. These outputs make the event record commercially usable while preserving correction and auditability.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 39. Clearing, Exchange, and Index Outputs

The gateway may output clearing signals, exchange eligibility signals, settlement instructions, reconciliation signals, exception signals, index updates, trust index values, behavior index values, time index values, communication index values, publication index values, domain index values, material index values, and discipline index values.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 40. Correction Triggers

Correction triggers may include fraud, unauthorized access, forged identity, coerced authorization, wrong endpoint, stale policy, duplicate minting, duplicate clearing, privacy breach, confidential disclosure violation, misclassification, AI error, terminal compromise, sensor error, publication dispute, licensing dispute, or jurisdictional order.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 41. Finality Conditions

Finality may occur after proof validation, governance approval, correction-window expiration, dispute resolution, licensing execution, transfer confirmation, clearing completion, exchange listing completion, index publication, or a policy-defined finality condition. Finality may be reversible only under exceptional correction rules if policy permits.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 42. Technical Advantages

The gateway improves endpoint-context resolution, cross-namespace interoperability, event normalization, identity anchoring, proof generation, privacy-preserving evidence handling, value conversion, bounded correction, and finality assignment. The technical contribution is the integrated state machine and data-object workflow, not a marketing concept.

The integrated state machine can reduce inconsistent computer states by locking consumed proof objects, enforcing correction windows, and assigning finality states that prevent duplicate minting, duplicate clearing, duplicate licensing, duplicate publication, unauthorized reopening, and replay of final or closed records.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 43. Difference From Messaging Systems

A messaging system may transmit a message but usually does not convert a typed event into a proof object, value-conversion record, correction state, licensing package, clearing signal, index update, and finality state. The present gateway provides those additional technical operations.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 44. Difference From Tokenization Systems

A tokenization system may issue a token, but may not bind a routed endpoint, identity anchor, typed event, time marker, proof object, governance profile, bounded correction controller, and finality controller. The present gateway requires an integrated conversion path rather than mere token issuance.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 45. Difference From Domain Name Systems

A domain name system may resolve names, but the claimed gateway is not limited to domain names and does not merely resolve names. It resolves or associates endpoint contexts with identity, event, proof, value conversion, correction, and finality states.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 46. Difference From Publication Registries

A publication registry may store documents, but it may not generate event-bound proof objects, licensing packages, value-conversion records, correction states, clearing signals, marketplace signals, index updates, and finality states. The present gateway can turn publication and disclosure events into structured value records.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 47. Difference From Payment Systems

A payment system may move value, but the claimed gateway may process authorization or payment-confirmation events without being the payment system itself. It establishes proof, correction, and finality structures around event-derived value records.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 48. Interoperability With Related Systems

The gateway can interoperate with service buses, data buses, telehealth systems, wallets, clearing systems, marketplaces, domain portals, IoT devices, AI agents, proof systems, publication systems, patent disclosure systems, and index engines. Interoperability does not make any one of those systems required.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 49. Example Operating Sequence—Communication

A user sends a voice message through an endpoint. The endpoint-context resolver creates routing context; the identity-anchor verifier authenticates the user or device; the event is classified as a communication event; the governance gate evaluates risk and authorization; the time-marker module binds a session window; the proof-object generator creates a proof; the value-conversion engine creates a communication value record; the correction controller sets a correction window; and the finality controller closes the record after conditions are met.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 50. Example Operating Sequence—Patent Publication

An inventor publishes a technical disclosure through a publication endpoint. The endpoint context includes publication node and identity information. The disclosure object includes title, inventor reference, document hash, figure reference, claim family, and confidentiality state. The gateway generates a publication proof, vault record, licensing package, transfer signal, valuation metadata, index update, and finality state.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 51. Example Operating Sequence—IoT Terminal

A sensor or terminal generates a service event. The terminal certificate and device context are bound to the event. The gateway verifies the identity anchor, binds the time marker, generates a proof object, determines whether the event should generate a service unit or value record, applies correction controls, and later assigns a finality state.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 52. Example Operating Sequence—Strategy-Governed Event

A high-risk event is processed with a strategy-governance profile. The profile supplies routing priority, escalation status, deception risk, confidentiality scope, licensing readiness, or value eligibility. The governance gate may output proof-only, delay, quarantine, mint-eligible, transfer-eligible, index-only, or denial states.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 53. Example Operating Sequence—Finality Closure

After proof validation and correction-window expiration, the finality controller assigns a final or closed state. The finality state may prevent reminting, duplicate publication, duplicate clearing, unauthorized transfer, or replay. The gateway may still preserve audit references and correction annotations for authorized review.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 54. Implementation Without BEI Branding

A third-party implementation may use a different brand, identity namespace, token name, endpoint system, or value unit. The same claimed gateway can be implemented where the third party uses enterprise accounts, wallet addresses, device IDs, public keys, or application accounts, provided that the system performs the endpoint-to-identity-to-event-to-proof-to-value-to-correction-to-finality workflow.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 55. Implementation With BEI Ecosystem Examples

In BEI embodiments, identity anchors may include BEIDID, BEIEID, or BehaviorID; value units may include BEI Currency, BICurrency, TimeCurrency, or communication assets; endpoints may include BEICOMMS.com, BEISIGN.com, BEIPROOF.com, BEIMINT.com, ATMS.com, BEIGX.com, BEISX.com, BEIIndex.com, BEICLAWBACK.com, BEIROLLBACK.com, BEIFR2.com, 120.us, MedicalCenter.us, 36JI.com, SZBF.com, ZGRX.com, Hours.us, days.us, week.us, year.us, and yrs.us, as non-limiting examples only.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway. 56. Claim Support—Independent System Claim

The system claim is supported by the described endpoint-context resolver, identity-anchor verifier, typed-event intake module, governance gate, time-marker module, proof-object generator, value-conversion engine, bounded correction controller, output interface, and finality-state controller. Each component has defined inputs, outputs, and operational relationships.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 57. Claim Support—Independent Method Claim

The method claim is supported by the representative operating sequences and module descriptions. The steps include receiving a typed event, resolving endpoint context, verifying identity, classifying the event, applying governance, binding time, generating proof, generating value-conversion record, applying correction, outputting signals, and assigning finality.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 58. Claim Support—Computer-Readable Medium

The computer-readable medium claim is supported by instructions for endpoint resolution, identity verification, event classification, governance, time marking, proof generation, value conversion, correction control, output generation, and finality assignment. The instructions may be stored and executed in servers, devices, terminals, gateways, cloud systems, local systems, or hybrid systems.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 59. Industrial Applicability

The invention is applicable to communications, AI-agent systems, enterprise workflows, IP publication platforms, technical disclosure portals, IoT infrastructures, device networks, service authorization systems, marketplaces, wallets, clearing systems, index engines, and value-finality systems. It addresses practical technical problems of verification, proof, value conversion, correction, and finality.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 60. Commercial and Licensing Utility

Commercial value may arise from gateway licensing, endpoint integration, proof-object services, publication proof services, marketplace listing services, identity verification services, correction-control services, finality-state services, and index update services. The gateway can serve enterprises, communication platforms, AI platforms, IP marketplaces, RWA systems, IoT networks, financial messaging systems, and sovereign or institutional infrastructures.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 61. Narrower Allowable Embodiments

If broad claims face prior-art or eligibility challenges, narrower embodiments may focus on communication or authorization events that are bound to an identity anchor, time marker, proof object, value-conversion record, bounded correction state, and finality state. Such narrower claims remain commercially valuable because they protect the point where events become correctable and finalizable value records.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 62. No Self-limiting Interpretation

The applicant intends that terms such as BEI, domain name, rooted domain, specific endpoint names, token names, NFT names, or currency names be interpreted as non-limiting examples unless they appear expressly as limitations in a claim. The invention is defined by structures, operations, data objects, interfaces, and states.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

### 63. Conclusion

The disclosure provides a broad but concrete gateway for converting events into value records. It is broad enough to avoid brand, domain, root, token, or currency workarounds, and concrete enough to be implemented as a computer system using identifiable modules, data objects, outputs, correction controls, and finality states.

The described operation may be implemented in a centralized, distributed, federated, peer-to-peer, device-local, cloud, ledger-based, enterprise, sovereign, institutional, or hybrid architecture. The implementation form is not limiting when the claimed elements are present.

The module may communicate by API, message queue, event bus, secure channel, ledger call, smart contract call, database transaction, service call, terminal message, device signal, or equivalent machine communication. The invention does not require a specific transport protocol unless expressly claimed.

The output of this module is used by downstream modules in a state-dependent manner, thereby avoiding a mere aggregation of unrelated components. The state machine relationship is a central technical aspect of the disclosed gateway.

Non-limiting implementation examples may include BEICOMMS.com, BEISIGN.com, BEIPROOF.com, BEIMINT.com, ATMS.com, BEIGX.com, BEISX.com, BEIIndex.com, BEICLAWBACK.com. BEIROLLBACK.com. BEIFR2.com. 120.us. MedicalCenter.us. 36JI.com, SZBF.com, ZGRX.com, Hours.us, days.us, week.us, year.us, yrs.us, and equivalent endpoints, accounts, identifiers, or namespaces. These examples may serve as portals, endpoints, namespace references, implementation websites, APIs, marketplaces, proof services, time-domain references, correction-control endpoints, rollback or clawback endpoints, audit endpoints, or strategy endpoints. The technical invention is not limited to any listed domain name, brand name, website, token name, root domain, DNS implementation, or endpoint provider. Equivalent non-domain, rootless, cryptographic, institutional, device, wallet, application, content-addressed, or machine-resolvable endpoints may implement the same claimed structure.

What is claimed is:

1. A computer-implemented event value-conversion gateway system, comprising: an endpoint-context resolver configured to resolve an addressable endpoint into an event routing context, wherein the addressable endpoint comprises a rooted, rootless, hierarchical, flat, decentralized, federated, cryptographic, device-based, session-based, content-addressed, institutional, user-controlled, or equivalent namespace reference; an identity-anchor verifier configured to verify a subject identity, terminal identity, device identity, wallet identity, institutional identity, cryptographic identity, behavior-linked identity, event-linked identity, or equivalent identity anchor associated with a typed event; a typed-event intake module configured to receive the typed event from a communication, expression, authorization, payment-confirmation, service, IoT, terminal, AI-agent, community, publication, disclosure, transaction, or life-time economic event source; a governance gate configured to evaluate event type, endpoint context, identity assurance, risk, policy, authorization, confidentiality, value eligibility, correction eligibility, or finality eligibility; a time-marker module configured to bind the typed event to a time marker, validity window, correction window, settlement window, publication window, or finality window; a proof-object generator configured to generate a proof object including at least one of an event hash, identity reference, endpoint reference, time marker, signature, nonce, policy version, evidence pointer, anti-replay state, or correction-window reference; a value-conversion engine configured to generate a value-conversion record from the proof object and the typed event; a bounded correction controller configured to apply a disputed, frozen, masked, annotated, corrected, recalled, clawed-back, rolled-back, reissued, invalidated, or restricted state to the value-conversion record in response to a trigger condition; an output interface configured to transmit at least one of a publication proof, licensing signal, transfer signal, mint instruction, clearing signal, settlement signal, exchange eligibility signal, marketplace signal, audit signal, valuation signal, or index update; and a finality-state controller configured to assign a pending, proofed, published, licensed, transferred, minted, disputed, frozen, corrected, clawed-back, rolled-back, cleared, settled, indexed, final, or closed state to the value-conversion record according to proof, policy, correction-window, clearing, settlement, publication, licensing, transfer, marketplace, indexing, or finality conditions.

2. A computer-implemented method for converting a typed event into a proof-bearing value record, the method comprising: receiving, by one or more processors, the typed event from an addressable endpoint; resolving, by an endpoint-context resolver, the addressable endpoint into an event routing context; verifying, by an identity-anchor verifier, an identity anchor associated with the typed event; classifying the typed event as a communication, expression, authorization, payment-confirmation, service, IoT, terminal, AI-agent, community, publication, disclosure, transaction, or life-time economic event; applying a governance profile to determine event eligibility; binding the typed event to a time marker or time window; generating a proof object from the typed event, the identity anchor, the event routing context, and the time marker;
generating a value-conversion record from the proof object according to a policy-defined value rule; outputting at least one of a vault record, publication proof, licensing signal, transfer signal, mint instruction, clearing signal, exchange eligibility signal, marketplace signal, audit signal, valuation signal, or index update; applying a bounded correction state to the value-conversion record when a trigger condition is detected; and assigning a finality state to the value-conversion record after proof, policy, correction-window, clearing, settlement, licensing, transfer, marketplace, indexing, or finality conditions are satisfied.

3. A non-transitory computer-readable medium storing instructions that, when executed by one or more processors, cause the one or more processors to perform operations comprising:
resolving an addressable endpoint into an event routing context; verifying an identity anchor associated with a typed event; classifying the typed event into at least one event category;
applying a governance profile to the typed event; binding the typed event to a time marker;
generating a proof object; generating a value-conversion record; storing or transmitting a vault record, disclosure record, licensing signal, transfer signal, mint instruction, clearing signal, exchange eligibility signal, marketplace signal, valuation signal, audit signal, or index update;
applying a bounded correction state to the value-conversion record in response to a trigger condition; and assigning a finality state to the value-conversion record.

4. The system of claim 1, wherein the addressable endpoint comprises a domain name, subdomain, DNS record, ENS name, DID, URI, URL, IP address, wallet address, public key identifier, device identifier, IoT endpoint, telephone identifier, application account, QR-code identifier, NFC identifier, content hash, session identifier, institutional identifier, national identity reference, enterprise account, publication endpoint, or equivalent routable endpoint.

5. The system of claim 1, wherein the typed event comprises a voice event, video event, message event, data exchange, AI-agent dialogue, command, signal, broadcast, authorization event, payment-confirmation event, service request, IoT observation, terminal interaction, community participation event, governance event, patent-publication event, material-disclosure event, structure-disclosure event, system-disclosure event, discipline-publication event, dataset event, standard-publication event, protocol-publication event, resource event, or life-time economic event.

6. The system of claim 1, wherein the identity anchor comprises a BEIDID, BEIEID, BehaviorID, domain-bound identity, wallet-bound identity, terminal-bound identity, device certificate, secure enclave identifier, public key, passkey, institution-issued credential, national identity reference, enterprise identity, sovereign identity, personal identity, or behavior-linked identity.

7. The system of claim 1, wherein the governance gate is configured to output allow, deny, delay, escalate, de-escalate, quarantine, proof-only, publish-eligible, license-eligible, transfer-eligible, mint-eligible, clear-eligible, index-only, correction-required, or finality-ready states.

8. The system of claim 1, further comprising a strategy-governance doctrine layer configured to supply a machine-readable strategy profile including routing priority, deception-risk indicator, escalation rule, de-escalation rule, emergency level, confidentiality scope, authorization threshold, publication eligibility, licensing readiness, transfer eligibility, value eligibility, or index weighting.

9. The system of claim 8, wherein non-limiting strategy endpoint examples comprise 36ji.com, szbf.com, a Thirty-Six Stratagems strategy engine, a Sunzi Bingfa strategic-governance endpoint, an enterprise policy engine, an institutional rules engine, or an equivalent machine-readable doctrine profile source.

10. The system of claim 1, wherein the time marker comprises a session marker, minute marker, hour marker, day marker, week marker, month marker, year marker, timestamp, nonce, counter, correction window, publication window, settlement window, policy-defined interval, R1.us reference, days. us reference, week. us reference, year. us reference, or equivalent time-domain namespace reference.

11. The system of claim 1, wherein the proof object comprises an event hash, identity hash, endpoint hash, payload hash, disclosure hash, time marker, nonce, counter, signature, credential reference, sensor attestation, policy version, governance profile reference, correction-window reference, anti-replay state, or vault pointer.

12. The system of claim 1, wherein the value-conversion record comprises a mint certificate, tokenized asset record, principal value unit, time-denominated value unit, communication asset, behavior asset, service unit, publication asset, patent-disclosure asset, material-disclosure asset, structure-disclosure asset, system-disclosure asset, discipline-index record, domain asset, licensing package, transfer package, clearing record, marketplace record, or index record.

13. The system of claim 1, further comprising a vault or disclosure-record module configured to store an encrypted event record, hash pointer, proof object, asset reference, publication record, patent object, material object, structure object, system object, discipline object, dataset object, protocol object, standard object, lifecycle state, confidentiality state, correction state, or finality state.

14. The system of claim 1, wherein the output interface is configured to transmit a publication proof, inventor-identity proof, domain-endpoint proof, disclosure proof, licensing package, transfer package, marketplace-listing signal, valuation metadata, clearing instruction, settlement instruction, exchange eligibility signal, audit snapshot, or index update.

15. The system of claim 1, wherein the bounded correction controller is configured to execute callback, clawback, rollback, freeze, masking, annotation, dispute marking, reissuance, invalidation, reversal, expiration, or restriction while preserving a privacy-protected audit trail.

16. The system of claim 1, wherein the finality-state controller is configured to prevent unauthorized reminting, duplicate clearing, duplicate publication, duplicate licensing, duplicate transfer, duplicate indexing, replay, or unauthorized reopening of a final or closed value-conversion record.

17. The method of claim 2, wherein applying the governance profile comprises applying a strategy-governance profile to determine publication eligibility, disclosure scope, confidentiality state, licensing readiness, transfer eligibility, dispute escalation, rollback eligibility, finality status, or index weighting.

18. The method of claim 2, wherein the typed event is associated with a personalized identity terminal or IoT endpoint that binds a device identifier, terminal certificate, secure enclave identifier, sensor identifier, user identity, endpoint reference, and time marker to the typed event.

19. The method of claim 2, wherein generating the value-conversion record comprises generating or transmitting a policy-defined value unit, principal currency instruction, time-currency instruction, communication asset instruction, behavior asset instruction, service-unit instruction, patent-disclosure asset instruction, material-disclosure asset instruction, clearing signal, marketplace signal, or index update.

20. The non-transitory computer-readable medium of claim 3, wherein the operations are implemented using one or more addressable endpoint ecosystems, each including one or more machine-resolvable namespace references, signed endpoint records, identity-anchor services, proof services, minting services, correction services, clearing services, exchange services, marketplace services, index services, or audit services, including, as non-limiting examples only, BEICOMMS.com, BEISIGN.com, BEIPROOF.com, BEIMINT.com, ATMS.com, BEIGX.com, BEISX.com, BEIIndex.com, BEICLAWBACK.com, BEIROLLBACK.com, BEIFR2.com, 120.us, MedicalCenter.us, 36JI.com, SZBF.com, ZGRX.com, Hours.us, days.us, week.us, year.us, yrs.us, or equivalent endpoints, wherein no particular domain name, brand name, website, token name, root domain, DNS implementation, or endpoint provider is required unless expressly recited as a required limitation.
